(19) United States
(12) Patent Application Publication
(10) Pub. No.: US 2008/0164135 A1
(43) Pub. Date: Jul. 10, 2008

(54) Solar Desalination Apparatus

(76) Inventor: Avraham Slook, Haifa (IL)

Correspondence Address: Pearl Cohen Zedek Latzer, LLP, 1500 Broadway, 12th Floor, New York, NY, 10036, US

(21) Appl. No.: 11/795,810

(22) PCT Filed: Jan. 19, 2006
(86) PCT No.: PCT/IL06/00086

§ 371 Date: Jul. 23, 2007

Related U.S. Application Data
(60) Provisional application No. 60/645,020, filed on Jan. 21, 2005.

(51) Int. Cl. C02F 1/14; F28B 1/02; G01S 3/786

(52) U.S. Cl. 202/83; 250/203.4

(57) ABSTRACT

A desalination apparatus for desalination of seawater or salty water, and purification of non-potable water, the apparatus comprising: a solar concentrator dish; a sun tracking system comprising at least one sensor for determining the relative position of the sun in the sky and a turning and a tilting mechanism for turning and tilting the dish towards the sun; an evaporation chamber positioned at a focal point of the solar concentrator dish, with an inlet linked to a non-potable water source; a condenser fluidically linked with the evaporation chamber for condensing vapor exiting the evaporation chamber into liquid; an outlet fluidically linked to the condenser for dispensing the condensed desalinated water; and a control unit for controlling entry of non-potable water into the evaporation chamber and for controlling the turning and tilting mechanism of the apparatus, cooperating with the sun-tracking system, all of which are supported on a stand.

### FIELD OF THE INVENTION

The present invention relates generally to solar desalination apparatus and more specifically it relates to a solar desalination and distillation system and method for providing a self-contained, mobile and efficient system for desalination of seawater or salty water and purification of non-potable water.

### BACKGROUND OF THE INVENTION

Water shortages affect a large portion of the world population even today. Many areas of the globe are dry. Other disaster stricken areas of the world are cut off water supply. In fact the availability of potable water is expected to drop in many countries due to salination or contamination of water sources, which is accelerated due to fast industrialization and poor environmental control.

Desalination of non-potable water is a known solution. Basically it involves evaporating salinated or contaminated water and condensing the vapor to obtain pure water.

A solar still is a primitive yet effective device for distilling water, and had been used by nomads in the desert and wilderness. It involves digging a pit in the ground at a damp location, covering it with a sheet in the form of a dome, and utilizing the greenhouse effect that causes the damp soil to release vapor that condenses on the dome and trickles into a cup or container. See for example, U.S. Pat. No. 3,415,719 (Telkes), U.S. Pat. No. 4,959,127 (Michma), U.S. Pat. No. 4,135,985 (La Rocca).

U.S. Pat. No. 4,325,788 (Snyder) discloses a solar distillation unit capable of operating entirely on solar radiation and intended for large scale industrial use offshore. A lens focusing system housed within an enclosed shell focuses the incident radiation from the sun on a heating element. Saltwater or contaminated fresh water is ejected toward the heating element at a predetermined rate resulting in the immediate evaporation of the water. The water vapor migrates and condenses on the cooler inner surface of the shell running to the bottom where it is collected and removed as fresh water.

GB 2341675 (Michaelis) discloses a solar collector comprising a spherical reflector dish focusing onto an element to be heated or a photovoltaic generator. The spherical reflector dish is mounted on a base and has a sun locating means. The solar collector may be formed from flat triangular elements, which may be laser cut and scored on their non-reflective side so that they can be folded. The sun locating means may comprise a square tube which intersects the dish creating when it is aligned with the sun an equal sized image on the ground. This may used to align the dish towards the sun.

U.S. Pat. No. 4,249,515 (Page) discloses a solar energy heating apparatus comprising means for concentrating solar energy incident thereon at an absorption station, an absorber located at the said absorption station for absorbing solar energy concentrated thereat, a first passageway associated with the said energy concentrating means for directing fluid so as to be preheated by the proportion of the incident energy absorbed by the said means, a second passageway associated with the absorber for effecting principal heating of fluid directed therethrough, the second passageway being such that on directing fluid through the first passageway it is initially preheated by the proportion of the incident energy absorbed by the said energy concentrating means, the preheated fluid thereafter being directed to the second passageway where the principal heating takes place.

Other solar energy systems are disclosed, for example, in WO 03/036187; U.S. Pat. No. 4,343,295; U.S. Pat. No. 5,650,050.

In U.S. Pat. No. 4,220,136 (Penney) a sun tracking solar energy collector assembly is disclosed, having both a longitudinally extending flat plate absorber and a tube absorber spaced from and extending longitudinally generally parallel to the flat plate absorber. In one form a parabolic reflector focuses direct rays of solar radiation on the tube absorber and directs diffused rays of solar radiation onto the plate absorber. In another form a Fresnel lens plate focuses direct rays of solar radiation on the tube absorber and flat reflector surfaces direct diffused solar radiation passing through the lens plate onto the plate absorber. In both forms a fluid is first heated as it circulates through passages in the flat plate absorber and then is further heated to a higher temperature as it passes through the tube absorber.

U.S. Pat. No. 4,290,411 (Russel) discloses a solar energy collector mounted for adjustable azimuth rotation about a vertical axis and adjustable elevation tilting about a horizontal axis for pointing toward the sun. The collector is driven for rotation about the vertical axis and for tilting about the horizontal axis by drive mechanism controlled by the angle of incidence of the sun's rays to the collector when the insulation is above a predetermined intensity. When the insulation is below such predetermined value, the drive mechanism is controlled by a stored computerized program. Control responsive to the sun's rays is effected by at least one light sensitive photoelectric cell. Preferably one pair of cells is arranged in a horizontal axis and another pair is arranged in a plane perpendicular to such horizontal axis. The photoelectric cells are buried in shield tubes to shield the cells from stray light. However, the outer end of the tubes are canted to increase the field from which direct rays from the sun will activate the photoelectric cells. Switching between control responsive to sun's rays and control by a computerized program is effected by a light level sensitive photoelectric cell. Further, the collector rotating and tilting drive mechanism is responsive to a stored computerized program that will effect return of the collector from a terminal position at sunset to an initial position for reactivation at sunrise of the following day.

A parabolic reflector having support structure, is disclosed in U.S. Pat. No. 4,568,156 (Dane) mounted upon a rotatable track, for supporting a parabolic dish framework to which is mounted one or more support panels to which, in turn, are pivotally mounted a plurality of reflectors for focusing rays on a linear collector. The support panels include a plurality of concave recesses operable to receive bowl-shaped reflectors provided with polygonal rims so that the sides of adjacent reflectors will be in registry with one another. The support panels are provided with bolts, outwardly extending from the base of each recess, the bolts being received in slotted apertures in each reflector bowl for pivoting and fastening the reflector in a pre-selected position for focusing solar rays upon the collector. The collector includes a heat exchange media operable to conduct heat at extremely high temperatures for production of steam. A novel tracking system is also provided.

It is an object of the present invention to provide a solar desalination and distillation system and method for providing a self-contained, mobile and efficient system for desalination of seawater or salty water, and purification of non-potable water. Furthermore, an additional object of the present invention is to provide a sun-tracking module and method, for directing a movable element toward the sun.

### SUMMARY OF THE INVENTION

There is thus provided, in accordance with some preferred embodiments of the present invention, a desalination apparatus for desalination of seawater or salty water, and purification of non-potable water, the apparatus comprising:

a solar concentrator dish;

a sun tracking system comprising at least one sensor for determining the relative position of the sun in the sky and a turning and a tilting mechanism for turning and tilting the dish towards the sun;

an evaporation chamber positioned at a focal point of the solar concentrator dish, with an inlet linked to a non-potable water source;

a condenser fluidically linked with the evaporation chamber for condensing vapor exiting the evaporation chamber into liquid;

an outlet fluidically linked to the condenser for dispensing the condensed desalinated water; and

a control unit for controlling entry of non-potable water into the evaporation chamber and for controlling the turning and tilting mechanism of the apparatus, cooperatingly with the sun-tracking system,

all of which are supported on a stand.

Furthermore, in accordance with some preferred embodiments of the present invention, the turning and tilting mechanism comprises at least two motors, one motor for turning the dish and another motor for tilting the dish.

Furthermore, in accordance with some preferred embodiments of the present invention, the tracking system further comprises a sensor matrix, having several sensors arranged in a perimeter and at least one sensor positioned substantially in the middle of the perimeter, the sensors provided with collimators to limit the field of view of the sensors.

Furthermore, in accordance with some preferred embodiments of the present invention, the apparatus further comprises a water level sensor linked with the evaporation chamber for detecting water level inside the evaporation chamber.

Furthermore, in accordance with some preferred embodiments of the present invention, the condenser comprises a heat exchanger.

Furthermore, in accordance with some preferred embodiments of the present invention, the heat exchanger comprises a pipe for evacuating vapor from the evaporation chamber, surrounded by another pipe for receiving cold water, which absorb heat from the vapor causing condensation of the vapor.

Furthermore, in accordance with some preferred embodiments of the present invention, the pipe for receiving cold water is fluidically linked to the non-potable water source and supplies non-potable water to the evaporation chamber.

Furthermore, in accordance with some preferred embodiments of the present invention, the non-potable water source comprises a container.

Furthermore, in accordance with some preferred embodiments of the present invention, the outlet is fluidically linked to a container for collecting the desalinated water.

Furthermore, in accordance with some preferred embodiments of the present invention, a pump is provided for transferring non-potable water into the evaporation chamber, the pump communicating with and receiving operation commands form the control unit.

Furthermore, in accordance with some preferred embodiments of the present invention, the container for collecting the condensed liquid includes a tap for dispensing the condensed purified water.

Furthermore, in accordance with some preferred embodiments of the present invention, power is provided by a solar power unit.

Furthermore, in accordance with some preferred embodiments of the present invention, power is provided by one or more batteries.

Furthermore, in accordance with some preferred embodiments of the present invention, the batteries are rechargeable batteries.

Furthermore, in accordance with some preferred embodiments of the present invention, there is provided a sun-tracking system for maneuvering a platform to track the motion of the sun across the sky, the system comprising:

a sensor matrix coupled to the platform, the sensor matrix comprising a plurality of photo-sensitive sensors arranged substantially around a perimeter and at least one sensor positioned substantially in the middle, the sensors provided with visors for selectively limiting incoming light to a predetermined sector;

a control unit for receiving signals from the sensors, for analyzing the position of the sun based on the signals form the sensors and for activating a turning and tilting mechanism for redirecting the platform.

Furthermore, in accordance with some preferred embodiments of the present invention, the visors comprise collimators.

Furthermore, in accordance with some preferred embodiments of the present invention, the sun-tracking system further comprises an additional sensor for sensing dawn, or incident of sunlight after a period of no direct sunlight.

Furthermore, in accordance with some preferred embodiments of the present invention, the additional sensor is positioned at an opposite side of the platform with respect to the sensor matrix.

Furthermore, in accordance with some preferred embodiments of the present invention, there is provided a method for facilitating tracking of the motion of the sun across the sky by a platform, the method comprising:

providing a sensor matrix coupled to the platform, the sensor matrix comprising a plurality of photo-sensitive sensors arranged substantially around a perimeter and at least one sensor positioned substantially in the middle, the sensors provided with visors for selectively limiting incoming light to a predetermined sector; and a control unit for receiving signals from the sensors, for analyzing the position of the sun based on the signals form the sensors and for activating a turning and tilting mechanism for redirecting the platform;

sensing signals from the sensor matrix, and when no signal is received from the sensor in the middle of the perimeter reorienting the sensor matrix in a direction corresponding to the position of a sensor on the perimeter that first senses sunlight, and stopping redirection of the sensor matrix when the sensor in the middle senses sunlight.

Furthermore, in accordance with some preferred embodiments of the present invention, the method further comprises providing an additional sensor for sensing dawn, or incident sun-light after a period with no direct sunlight, and upon sensing dawn or incident sunlight, redirecting the platform to a general direction of the sun at dawn, or where the sun is expected to be.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a general view of a solar desalination apparatus, in accordance with a preferred embodiment of the present invention.

FIG. 2 illustrates another view of the solar desalination apparatus shown in FIG. 1.

FIG. 3 illustrates an electrical control scheme in accordance with a preferred embodiment of the present invention, for a desalination apparatus.

FIG. 4 illustrates a heat-exchange unit, in accordance with a preferred embodiment of the present invention, for incorporation with a desalination apparatus according to the present invention.

FIG. 5 illustrates a cross-sectional view of an evaporation chamber of a solar desalination apparatus, in accordance with a preferred embodiment of the present invention.

FIG. 6 illustrates a proposed arrangement of sensors for collecting information for the control unit of the desalination apparatus, according to the present invention.

### DETAILED DESCRIPTION OF PREFERRED EMBODIMENTS

The present invention seeks to provide a novel self-contained portable solar desalination and distillation (hereinafter generally referred to as “desalination”) apparatus for desalination of seawater or salty water and purification of non-potable water.

An aspect of the present invention is the provision of an apparatus of portable proportions (although the present invention is not limited to these proportions), that generally comprises the following components: a solar concentrator capable of tracking the sun using a sunlight tracking device, an evaporation chamber placed at the focal point of the solar concentrator, a condenser, non-potable water inlet and potable water outlet. All these components are integrated in a single (preferably portable) apparatus.

The present invention provides a new solar desalination and distillation apparatus for desalination of seawater and purification of non-potable water. Non-potable water means all types of water that are unfit for human consumption and in particular, but not only, seawater or salty water. Non-potable water also includes, inter-alia, chemically contaminated water, sewer wastes, and other types of water that is unworthy of drinking.

To attain this, the present invention generally comprises non potable water tank, or other non-potable supply means, a water pump or other driving means for facilitating water flow from the non-potable water tank to an evaporation chamber, a reorientable solar ray collecting reflector, sun light tracking photoelectric sensors, motors that provide accurate and continuous orientation of the ray collecting reflector, a control unit that controls the activation of the motors, optional solar cells that provide energy to the motors and pumps, an evaporation chamber, a water level measurement unit inside the evaporation chamber, a heat exchanging unit, a condensation chamber and an outlet for delivering freshwater. The non-potable water tank typically has a volume of some 20 liters (but other volumes are possible too and covered by the scope of the present invention, depending on the volume requirements of the user). The solar reflector is typically a parabolic surface coated with reflective material, which focuses solar ray energy onto the evaporation chamber that is positioned at its focal point. The rotation and elevation motors control the positional elevation and rotation of the solar reflector, based on signals generated by the control unit after analyzing the status of the photoelectric sensors. The optional solar cells provide power to the elevation and rotation motors. Alternatively the apparatus is powered by batteries or mains power supply, for self-start, or for normal operation. The evaporation chamber according to a preferred embodiment of the present invention, comprises a hollow container made of a heat conducting metal or alloy such as brass. The evaporation chamber is located at the focal point of the solar ray collector and hence receives concentrated amount of solar energy. It is preferably painted in black to maximize the amount of heat absorption. The evaporation chamber has an intake of non-potable water and an outlet for the vapors generated. The heat exchanging unit/condensation chamber receives and cools down the vapors by dissipating excess heat to the surrounding air or water. The pure water tank is preferably a white painted container with means such as tap, hose, or pump, for dispensing the fresh water.

More advantages and additional features of the present invention are described with reference to the accompanying figures. It is to be understood that the invention is not limited in its application to the details of construction and to the arrangements of the components set forth in the following description or illustrated in the drawings. The invention can be realized in other embodiments and may be carried out in various ways. Also, it is to be understood that the phraseology and terminology employed herein are for the purpose of the description and should not be regarded as limiting.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

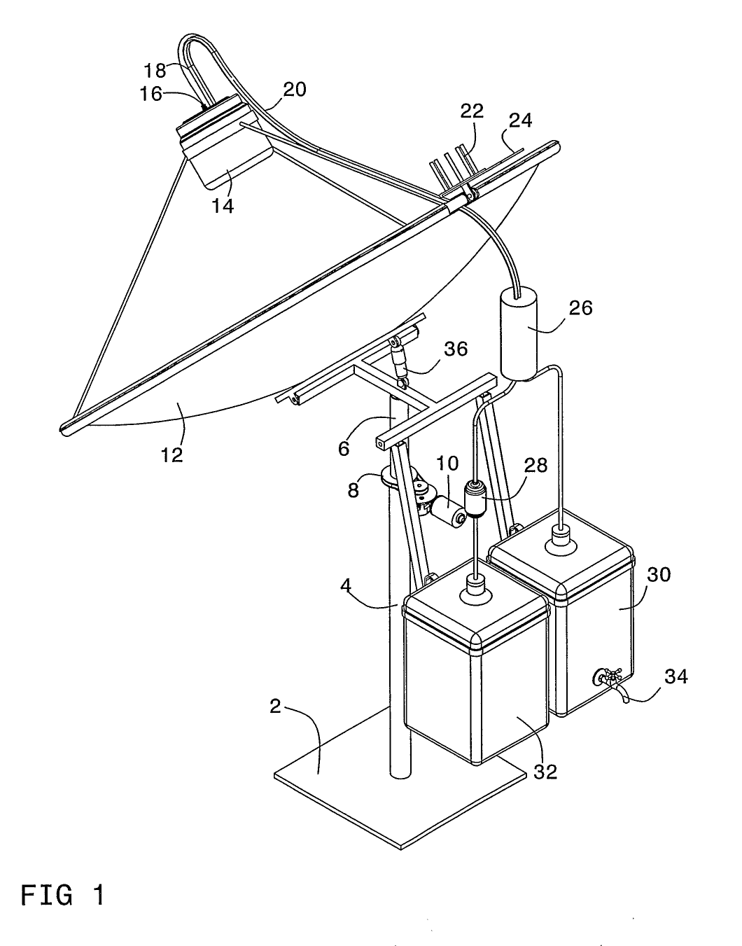

Reference is now made to FIG. 1 illustrating a general view of a solar desalination apparatus, in accordance with a preferred embodiment of the present invention.

The apparatus is supported on a stand 4, mounted on a base 2. The stand extends to present a rotating arm 6 that is actuated and operated by motor 10 via transmission 8, the motor being in charge of left and right motion. The extended arm is coupled to a solar concentrator dish 12 (see for example, U.S. Pat. No. 4,568,156, incorporated herein by reference) that concentrates solar rays at a focal point, where an evaporation chamber 14 is placed. The evaporation chamber is linked to a non-potable water supply (here in the form of non-potable water container 32, which pumps non-potable water, using pump 28 through inlet pipe 18 into the evaporation chamber 14, until water level measurement sensor 16 senses a correct water level inside the evaporation chamber and turns the water pump off. The evaporation chamber is also linked to pure water container 30, via outlet pipe 20 that is used to transmit vapor from the evaporation chamber to heat exchange unit 26, which condenses the vapor into liquid and delivers it into the pure water container 30. Outlet tap 34 is provided for dispensing the pure water from the pure water container. The evaporation chamber optionally further comprises a water level gauge sensor 16, for detecting the water level inside the evaporation chamber, the information on the water level being used by the control unit to determine whether more non-potable water needs to be pumped into the evaporation chamber.

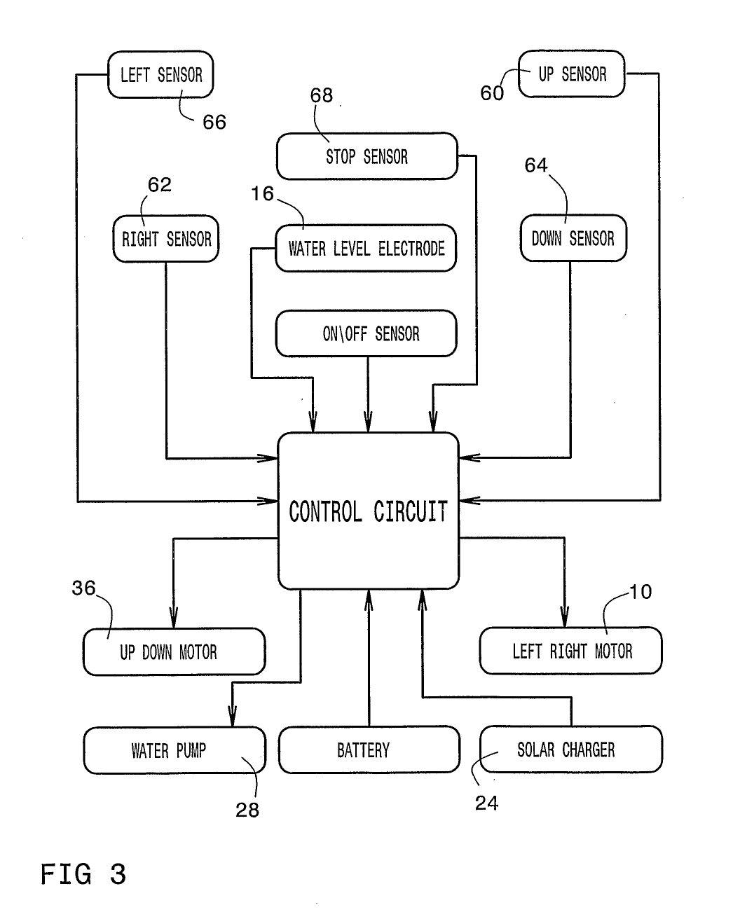

The solar concentrator dish 12 can be tilted up or down by motor 36. Both motors (10, 36) are controlled by a control unit (see FIG. 3). Sensors 22 are provided for detecting the sun position and elevation relative to the concentrator dish 12, and the sensed information is used by the control unit for issuing reorientation commands for the dish. Optional solar recharging unit 24 comprising an array of photovoltaic cells is provided for powering the electrical components of the apparatus.

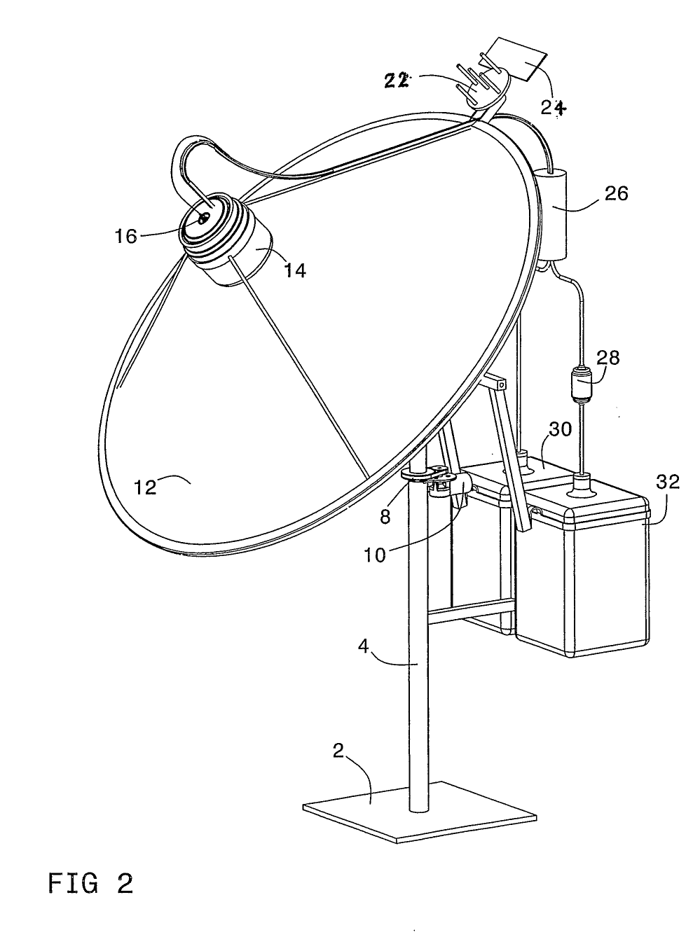

FIG. 2 illustrates another view of the solar desalination apparatus shown in FIG. 1.

FIG. 3 illustrates an optional electrical control scheme in accordance with a preferred embodiment of the present invention, for a desalination apparatus. The control circuit (or control unit), which is powered by a battery (or other power supply means, such as solar charger 24) receives input signals from left sensor 66, right sensor 62, up sensor 60, down sensor 64, stop sensor 68, water level gauge sensor 16 and an on/off sensor. Based on the input signals, and according to a predetermined scheme (program) the control unit sends operation commands to the up/down motor 36, the left/right motor 10, and the water pump 28. Pump 28 and/or the connecting pipe to the evaporation chamber preferably have a one-directional safety valve to prevent vapor from penetrating the pump or from traveling in the direction of the non-potable water source.

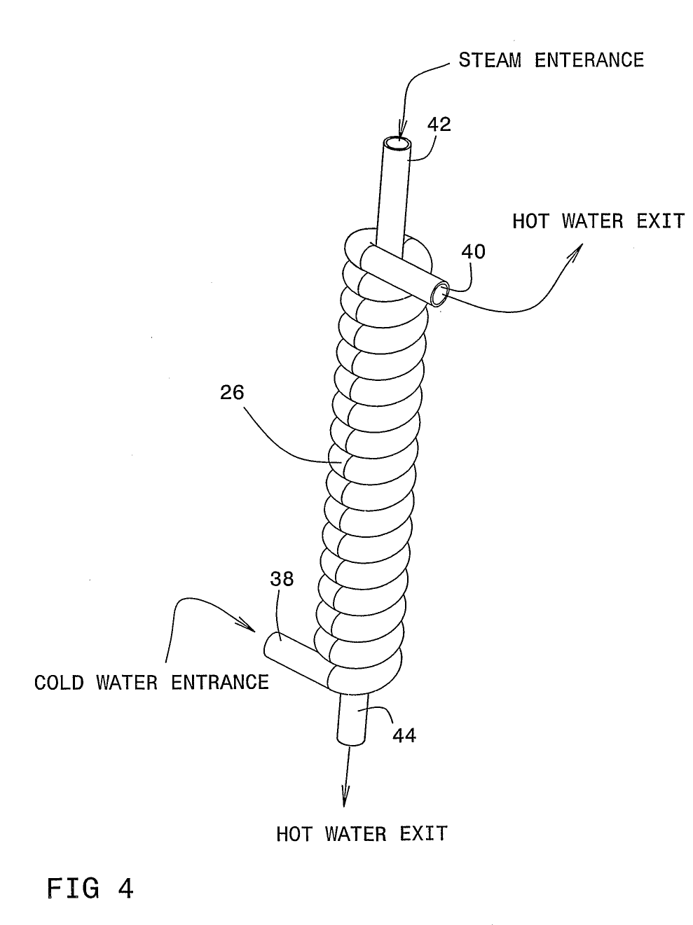

FIG. 4 illustrates an exemplary heat-exchange unit 26, in accordance with a preferred embodiment of the present invention, for incorporation with a desalination apparatus according to the present invention. Outlet pipe 20 (see FIG. 1) delivers steam (vapor) through into inlet 42. The pipe is surrounded by a heat-exchanger pipe through which cold water is passed via inlet 38 and absorbs heat from the vapor pipe 20, so that at outlet 40 hot water emerges. In some embodiments of the present invention (as in the embodiment shown in FIG. 1 and FIG. 2) non-potable water that is to be treated by the apparatus is first passed through the heat exchanger pipe, serving as heat-exchanging fluid, before it is delivered to the evaporation chamber. The fact that it is preheated merely serves in reducing the amount of energy that is required for transferring the non-potable water into vapor at the evaporation chamber, rendering the apparatus even more efficient.

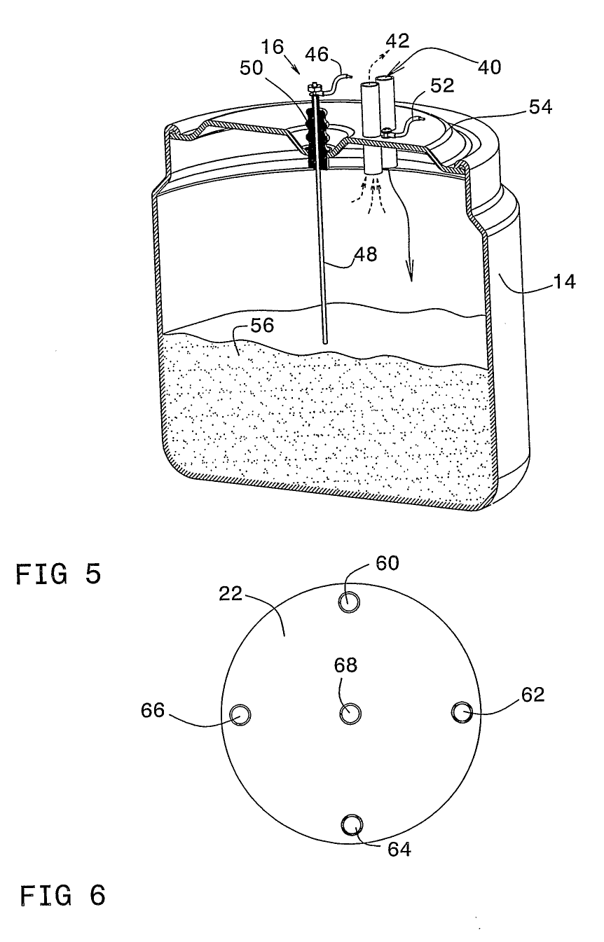

FIG. 5 illustrates a cross-sectional view of an evaporation chamber 14 of a solar desalination apparatus, in accordance with a preferred embodiment of the present invention. The non-potable water level 56 is monitored by the control unit using water level gauge sensor 16, here comprising an electrode 48 insulated by insulator 50 and transmitting reading signals via electric wire 46 to the control unit. The evaporation chamber is covered by cover 54, and is optionally equipped with a level sensor that is linked to the control unit via electrical wire 52. The cover is also provided with inlet and outlet pipes—pipe 42 delivering vapor from the evaporation chamber into the heat exchanger (condenser) and pipe 40 for receiving hot water from the heat exchanger.

FIG. 6 illustrates a proposed arrangement of sensors for sun-tracking cooperating with the control unit of the desalination apparatus, according to the present invention. This is another novel feature of the According to a preferred embodiment of the present invention, a sun-tracking mechanism is materialized by providing a set of sensors comprising photo sensitive sensors (for example, photo-resistors, photo-voltaic cells). The sensors are arranged in a matrix and are equipped with collimators or visors (see 22 in FIG. 1). The visors limit the “field of view” of the sensors effectively narrowing it to a predetermined angle, from all sides or from selected sides (that may be set according to the sensitivity requirements and the dimensions of the sensor matrix). The sensors with their mounted visors are distributed around a perimeter with at least one sensor substantially in the middle, and are collectively directed at a certain direction. As the sun irradiates light onto the sensor matrix the sensor that is closer to the sun is the first to sense the incident sun-ray and sends a signal to the control unit. The control unit reorients the sensor matrix towards the direction of the sensor that first senses the sun-ray. The orientation stops when one more of the sensors (typically the sensor in the middle) sense the sun-ray. As the sensor matrix is coupled to the solar concentrator dish this causes the entire solar concentrator dish to reorient itself towards the sun.

There are typically 6 sensors 22 (but other numbers of sensors are possible and covered by the scope of the present invention) in the system. Up motion sensor 60, down motion sensor 64, right motion sensor 62, left motion sensor 66, and stop sensor 68 (detecting sun rays on the middle sensor causes the reorientation process to halt). These sensors provide information (see explanation hereinabove) that is used for controlling the rotation and elevation motors, and for detecting whether the solar concentrator is properly oriented in the direction of the sun. As the sun progresses across the sky the middle sensor will eventually stop sensing the incident sun-rays and the sensor matrix will be redirected in the direction of the last sensor to sense the sun-light. An additional sensor may be used (see on/off sensor in FIG. 3) for restarting the orientation process at dawn, or upon renewed detection of sun-light, after a period with no direct sunlight (e.g. clouds). It is typically located at the back of the device but may be located at other parts of the device. At dawn it senses light from a direction that is substantially opposite the direction of the previous day's sun-light—as the sun sets in the west but rises in the east. When sun-light is temporary hidden it would generate a restart signal once sun-light returns and reaches the sensor.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. An apparatus for desalination of seawater or salty water, and purification of non-potable water, the apparatus comprising:
a solar concentrator dish;
a sun tracking system comprising at least one sensor for determining the relative position of the sun in the sky and a turning and a tilting mechanism for turning and tilting the dish towards the sun;
an evaporation chamber positioned at a focal point of the solar concentrator dish, with an inlet linked to a non-potable water source;
a condenser fluidically linked with the evaporation chamber for condensing vapor exiting the evaporation chamber into liquid;
an outlet fluidically linked to the condenser for dispensing the condensed desalinated water; and
a control unit for controlling entry of non-potable water into the evaporation chamber and for controlling the turning and tilting mechanism of the apparatus, cooperatingly with the sun-tracking system,
all of which are supported on a stand.

2. The apparatus as claimed in claim 1, wherein the turning and tilting mechanism comprises at least two motors, one motor for turning the dish and another motor for tilting the dish.

3. The apparatus as claimed in claim 1, wherein the tracking system further comprises a sensor matrix, having several sensors arranged in a perimeter and at least one sensor positioned substantially in the middle of the perimeter, the sensors provided with collimators to limit the field of view of the sensors.

4. The apparatus as claimed in claim 1, further comprising a water level sensor linked with the evaporation chamber for detecting water level inside the evaporation chamber.

5. The apparatus as claimed in claim 1, wherein the condenser comprises a heat exchanger.

6. The apparatus as claimed in claim 5, wherein the heat exchanger comprises a pipe for evacuating vapor from the evaporation chamber, surrounded by another pipe for receiving cold water, which absorb heat from the vapor causing condensation of the vapor.

7. The apparatus as claimed in claim 6, wherein the pipe for receiving cold water is fluidically linked to the non-potable water source and supplies non-potable water to the evaporation chamber.

8. The apparatus as claimed in claim 1, wherein the non-potable water source comprises a container.

9. The apparatus as claimed in claim 1, wherein the outlet is fluidically linked to a container for collecting the desalinated water.

10. The apparatus as claimed in claim 1, wherein a pump is provided for transferring non-potable water into the evaporation chamber, the pump communicating with and receiving operation commands form the control unit.

11. The apparatus as claimed in claim 1, wherein the container for collecting the condensed liquid includes a tap or a hose for dispensing the condensed purified water.

12. The apparatus as claimed in claim 1, wherein power is provided by a solar power unit.

13. The apparatus as claimed in claim 1, wherein power is provided by one or more batteries.

14. The apparatus of claim 13, wherein the batteries are rechargeable batteries.

15. A sun-tracking system for maneuvering a platform to track the motion of the sun across the sky, the system comprising:
a sensor matrix coupled to the platform, the sensor matrix comprising a plurality of photo-sensitive sensors arranged substantially around a perimeter and at least one sensor positioned substantially in the middle, the sensors provided with visors for selectively limiting incoming light to a predetermined sector;
a control unit for receiving signals from the sensors, for analyzing the position of the sun based on the signals form the sensors and for activating a turning and tilting mechanism for redirecting the platform.

16. The sun tracking system as claimed in claim 15, wherein the visors comprise collimators.

17. The sun tracking system as claimed in claim 15, further comprising an additional sensor for sensing dawn, or incident of sunlight after a period of no direct sunlight.

18. The sun tracking system of claim 17, wherein the additional sensor is positioned at an opposite side of the platform with respect to the sensor matrix.

19. A method for facilitating tracking of the motion of the sun across the sky by a platform, the method comprising:
Providing a sensor matrix coupled to the platform, the sensor matrix comprising a plurality of photo-sensitive sensors arranged substantially around a perimeter and at least one sensor positioned substantially in the middle, the sensors provided with visors for selectively limiting incoming light to a predetermined sector; and a control unit for receiving signals from the sensors, for analyzing the position of the sun based on the signals form the sensors and for activating a turning and tilting mechanism for redirecting the platform;
sensing signals from the sensor matrix, and when no signal is received from the sensor in the middle of the perimeter, reorienting the sensor matrix in a direction corresponding to the position of a sensor on the perimeter that first senses sunlight, and stopping redirection of the sensor matrix when the sensor in the middle senses sunlight.

20. The method as claimed in claim 19, further comprising providing an additional sensor for sensing dawn, or incident sun-light after a period with no direct sunlight, and upon sensing dawn or incident sunlight, redirecting the platform to a general direction of the sun at dawn, or where the sun is expected to be.
